(19) United States
(12) Patent Application Publication
(10) Pub. No.: US 2005/0158011 A1
(43) Pub. Date: Jul. 21, 2005

(54) Waveguide for use in dual polarisation probe system

(75) Inventor: Andrew Patrick Baird, Hampshire (GB)

Correspondence Address: DARBY & DARBY P.C., P. O. BOX 5257, NEW YORK, NY, 10150-5257, US

(73) Assignee: Channel Master Limited, Theale (GB)

(21) Appl. No.: 11/061,561

(22) Filed: Feb. 18, 2005

Related U.S. Application Data
(63) Continuation of application No. 10/684,173, filed on Oct. 10, 2003, now abandoned.
Application No. 10/684,173 is a continuation of application No. 10/094,187, filed on Mar. 8, 2002, now abandoned.
Application No. 10/094,187 is a continuation of application No. 09/254,771, filed on Jul. 12, 1999, now abandoned.
Application No. 09/254,771 is a continuation of application No. PCT/GB97/02428, filed on Sep. 9, 1997.

(30) Foreign Application Priority Data
Sep. 9, 1996 (GB) 9618744.8

(51) Int. Cl. G02B 6/00

(52) U.S. Cl. 385/147

(57) ABSTRACT

A waveguide for use with a dual polarization waveguide probe system is described which provides an improved frequency response across a desired frequency range (10.7 to 12.75 GHz) and particularly at the band edges. This is achieved by providing a waveguide with a rotator that incorporates a reflecting plane in combination with a differential phase shift portion in the form of a waveguide of slightly asymmetrical cross section so that orthogonal signals which travel through this portion have a different cut-off wavelength. This results in a rotator which achieves 180° of phase shift between two orthogonal components across the frequency range of signals received by the waveguide. The reflecting plate and the differential phase shift portion have inverse frequency characteristics so that the combined phase shift characteristic of the rotator has a flatter frequency characteristic.

The present invention relates to a waveguide for use in a dual polarisation waveguide probe system for use with a satellite dish receiving signals broadcast by a satellite which includes two signals orthogonally polarised in the same frequency band. In particular, the invention relates to an improved waveguide for use with a low-noise block receiver into which two probes are disposed for coupling from the waveguide, desired broadcast signals to external circuitry.

In applicant's co-pending Published International Application WO92/22938 there is disclosed a dual polarisation waveguide probe system in which a waveguide is incorporated into a low-noise block receiver in which two probes are located for receiving linearly polarised energy of both orthogonal senses. The probes are located in the same longitudinal plane on opposite sides of a single cylindrical bar reflector which reflects one sense of polarisation and passes the orthogonal signal with minimal insertion loss and then reflects the rotated orthogonal signal. The probes are spaced λ/4 from the reflector. A reflection rotator is also formed at one end of the waveguide using a thin plate which is oriented at 45° to the incident linear polarisation with a short circuit spaced approximately a quarter of a wavelength (λ/4) behind the leading edge of the plate. This plate splits the incident energy into two equal components in orthogonal planes, one component being reflected by the leading edge and the other component being reflected by the waveguide short circuit. The resultant 180° phase shift between the reflected components causes a 90° rotation in the plane of linear polarisation upon recombination so that the waveguide output signals are located in the same longitudinal plane.

Furthermore, in applicant's co-pending International Patent Application PCT/GB96/00332, an improved dual polarisation waveguide probe system was disclosed for use with a wider frequency range transmitted by new satellite systems. In this improved probe, a reflective twist plate was provided within the probe housing, the reflective twist plate having at least two signal reflecting edges so that at least two separate signal reflections are created. The multiple signal reflections enable the probe system to operate over a wider frequency range with minimal deterioration and signal output.

Although the improved version provides a better frequency response across the frequency range, it has been found that the losses level at the edges of the band still cause a significant performance degradation. With the increasing number of channels being used in satellite systems, it is desirable to be able to operate across the entire frequency band with substantially the same performance, in other words, to provide minimal degradation at the edges of the frequency band.

An object of the present invention is to provide an improved waveguide for use with a dual polarisation probe system which obviates or mitigates the aforementioned disadvantage.

This is achieved by providing a waveguide for use with a dual polarisation waveguide probe system which has a rotator which incorporates a reflecting plate in combination with a differential phase shift portion in the form of a waveguide of slightly asymmetrical cross section so that orthogonal signals which travel through this portion have a different cut-off wavelength. This results in a rotator which achieves 180° of phase shift between two orthogonal components across the frequency range of signals received by the waveguide. The reflecting plate and the differential phase shift portion have inverse frequency characteristics so that the combined phase shift characteristic of the rotator has a flatter frequency characteristic across the desired frequency range.

In a preferred arrangement, the rotator consists of a single reflector plate with a single reflecting surface and the differential phase shift portion has two pairs of flats cast into the waveguide bore, a first pair of flats being machined in at a first distance from the reflector plate and a second pair machined nearer to the reflector plate at a second distance from the reflector plate, the second pair of flats being machined less into the wall than the first pair so that the flats of the second pair are nearer to the reflector bore or central axis. In an alternative arrangement with rotator consists of a single reflector plate in an elliptical waveguide portion coupled to the cylindrical waveguide portion. The different cross-sections of the ellipse provide two different cut-off wavelengths for the orthogonal signals. The differential phase shift portion may be implemented by any other suitable structure which has a slight cross-sectional asymmetry to create wavelengths with different cut-offs.

According to a first aspect of the present invention, there is provided a waveguide for use with a dual polarisation waveguide probe system for receiving at least two signals which are orthogonally polarised, said waveguide comprising a waveguide tube into which at least two orthogonally polarised signals are received for transmission therealong, said waveguide having;
a first probe extending from a wall of the waveguide into the interior of the waveguide, said first probe being adapted to receive said orthogonal signal travelling in the same longitudinal plane thereof,
reflector means extending from the wall of the waveguide, through reflector means located downstream of the first probe lying in the longitudinal plane for reflecting signals in said first orthogonal plane back to said first probe means and allowing said signal in said second orthogonal plane to pass along the waveguide, second probe means located downstream of said first reflector means and extending from wall of said waveguide into the interior of the waveguide and lying in said longitudinal plane, signal reflecting and rotating means, including a short circuit at the end of the waveguide, located downstream of said second probe means for receiving, rotating and reflecting said second orthogonally polarised signal back along said waveguide such that the rotated and reflected signal is received by said second probe means, said signal reflecting and rotating means comprising a first reflecting and rotating means in the form of a plate with a leading edge thereon to provide at least one reflecting edge portion for reflecting a first component of said second orthogonally polarised signal, the reflecting edge portion being spaced at a desired distance from the short circuit at the end of the waveguide, a differential phase shift means disposed in proximity to the rotating plates, said differential phase shift means having a slightly asymmetrical cross-section, whereby said first and second components of said second orthogonally polarised signal are phase shifted with respect to each other in the differential phase shift portion, then reflected respectively from said reflecting edge portion and from said short circuit before being further phase shifted when travelling back through the differential phase shift portion for recombination, said first and second components having different cut-off wavelengths, to provide a recombined signal for detection by said second probe means.

Preferably, said reflecting and rotating means has a single reflecting edge portion across the width of the waveguide. Conveniently, the differential phase shift means is provided by an asymmetric structure in the form of flats cast into the interior of the waveguide structure. Preferably, two flats are provided on each side, the flats being parallel with and extending along the waveguide from the reflector plate. Alternatively, the slightly asymmetric portion is provided by an elliptical waveguide. Advantageously, the upstream flats are machined a greater distance into the waveguide surface than the downstream flats with the first (downstream) flats forming an impedance matching structure.

Conveniently, the waveguide differential phase shift means is provided by at least two pairs of stepped flats. Alternatively, the asymmetric portion may be provided by a smooth transition along the waveguide without a clear step instead of the flats. The smooth transition will be cast into the side of the waveguide parallel to the reflecting edge portion.

According to a second aspect of the present invention, there is provided a method of receiving at least first and second orthogonally polarised signals in a frequency range in a single waveguide and providing at least two outputs in a common longitudinal plane for providing a flatter characteristic across the frequency range, said method comprising the steps of,
providing a first probe in said waveguide to receive a first orthogonally polarised signal,
providing a reflecting means in said waveguide parallel to and downstream from said first probe for reflecting said first orthogonally polarised signal and for allowing passage of said second orthogonally polarised signal,
providing a second probe in said waveguide parallel to and downstream of said reflector means, said second probe being substantially orthogonal to said second orthogonally polarised signal which passes the second probe without being received by the second probe, providing a signal reflecting and rotating means at the end of the waveguide for reflecting a first component of said second orthogonal signal back towards said second probe,
allowing a second component of said second orthogonal signal to travel towards said waveguide short circuit, modifying the length of said second component such that it has a different cut-off wavelength from said first component,
reflecting said second component from said waveguide short circuit,
recombining said first and second reflected components of said second orthogonal signal to create a recombined reflected signal, said recombined reflected signal being in the same plane as said second probe for detection thereby, said first and second reflected components having inverse frequency characteristics which combine to create a flatter frequency response across said frequency range.

The reflecting and rotating means is formed by the combination of a differential phase shift section and a reflecting plate. The differential phase shift section is orientated at 45° to the incident signal such that a phase shift is introduced between the first and second portion of the orthogonal (horizontal) signal. A further phase shift is introduced by the reflecting plate downstream. The combination of these gives 180° phase shift between the two portion on recombination, providing a resultant signal in plane of said second probe.

According to another aspect of the present invention there is provided a dual polarisation waveguide probe structure, said structure having a waveguide, first and second probes disposed in the waveguide separated by a first reflector, said first and second probes and said reflector being disposed in the same plane, second probe signal providing means for providing a polarised component to said second probe, said second probe providing means comprising a signal reflecting and rotating means for reflecting and rotating a polarised component for reception by said second probe, said reflecting and rotating means comprising a reflected edge portion for reflecting a first component of said polarised signal, and a differential phase portion provided by a slightly asymmetrical waveguide portion and a waveguide short circuit for providing a reflected second component with a different cut-off wavelength from said first component, the first and second components having inverse frequency characteristics which when recombined provide a flatter frequency characteristic across the frequency range.

These and other aspect of the invention will become apparent from the following description when taken in combination with the accompanying drawings in which:—

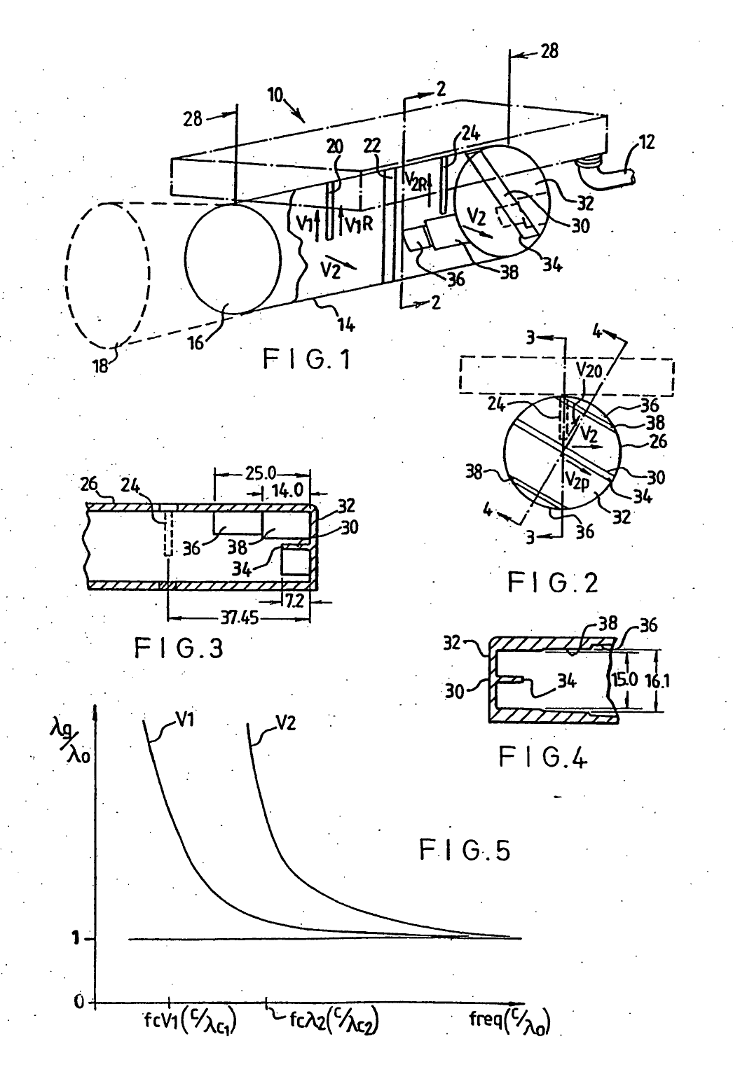

FIG. 1 is a partly broken away view of the low-noise block receiver with a waveguide probe including a waveguide with a reflecting plate and a waveguide differential phase shift means in accordance with a preferred embodiment of the present invention;

FIG. 2 is a cross-sectional view of the waveguide taken on the section 2-2 of FIG. 1;

FIG. 3 is a sectional view taken on the lines 3-3 of FIG. 2;

FIG. 4 is a sectional view taken on the lines 4-4 of FIG. 2;

FIG. 5 is a graph of the ratio of guide wavelength to free-space wavelength vs. frequency showing the guide wavelength as a function of frequency for two different wavelengths.

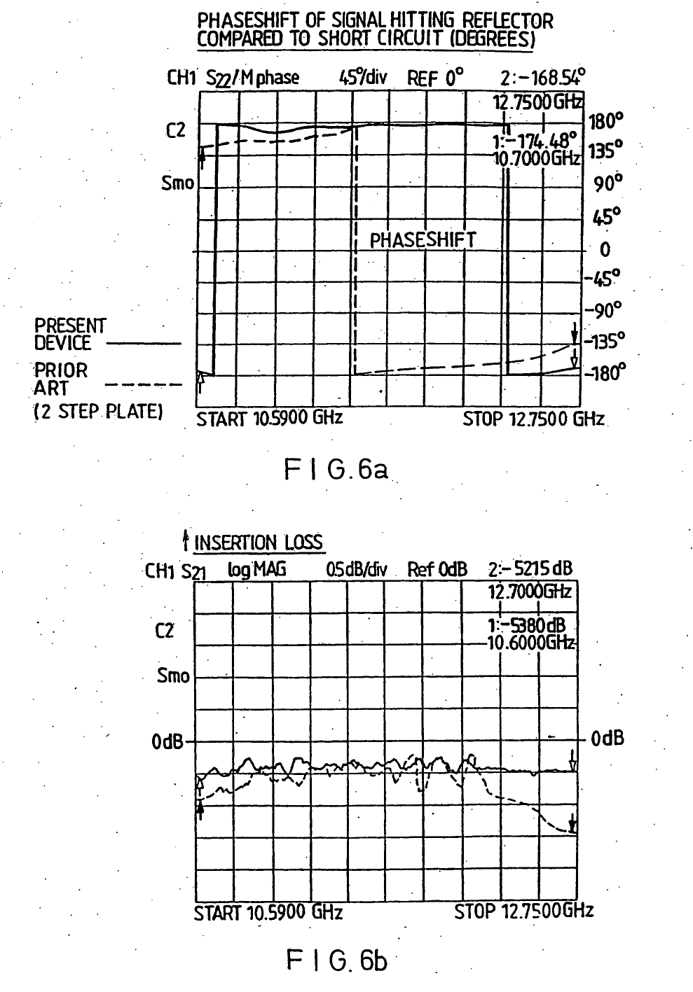

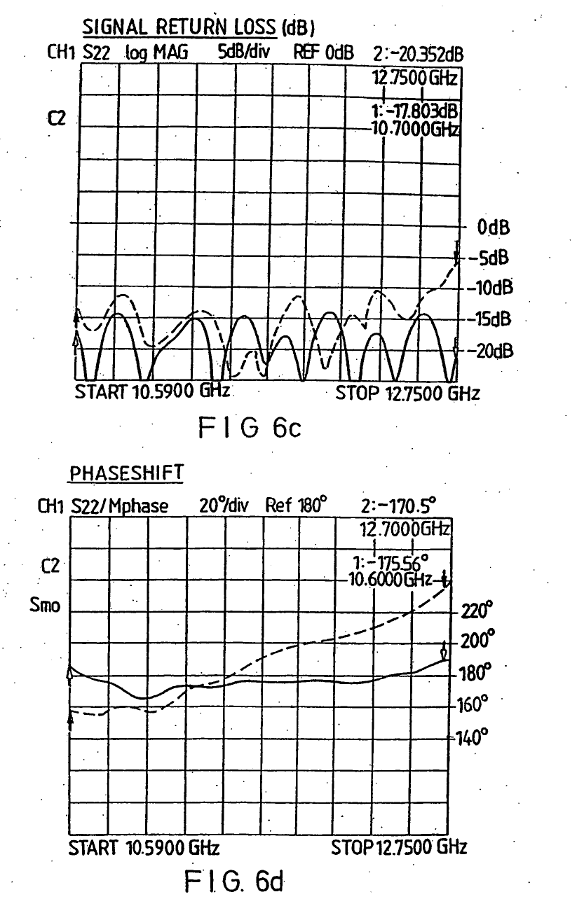

FIGS. 6a, b, c and d are graphs comparing the responses of the dual polarisation waveguide probe system with the waveguide according to the embodiments shown in FIGS. 1 to 6 wherein FIG. 6a is a graph of phase shift vs. frequency, FIG. 6b is a graph of insertion loss vs. frequency, FIG. 6c is a graph of return loss vs. frequency and FIG. 6d is a graph of phase shift vs. frequency similar to that shown in FIG. 6a but drawn to a larger scale.

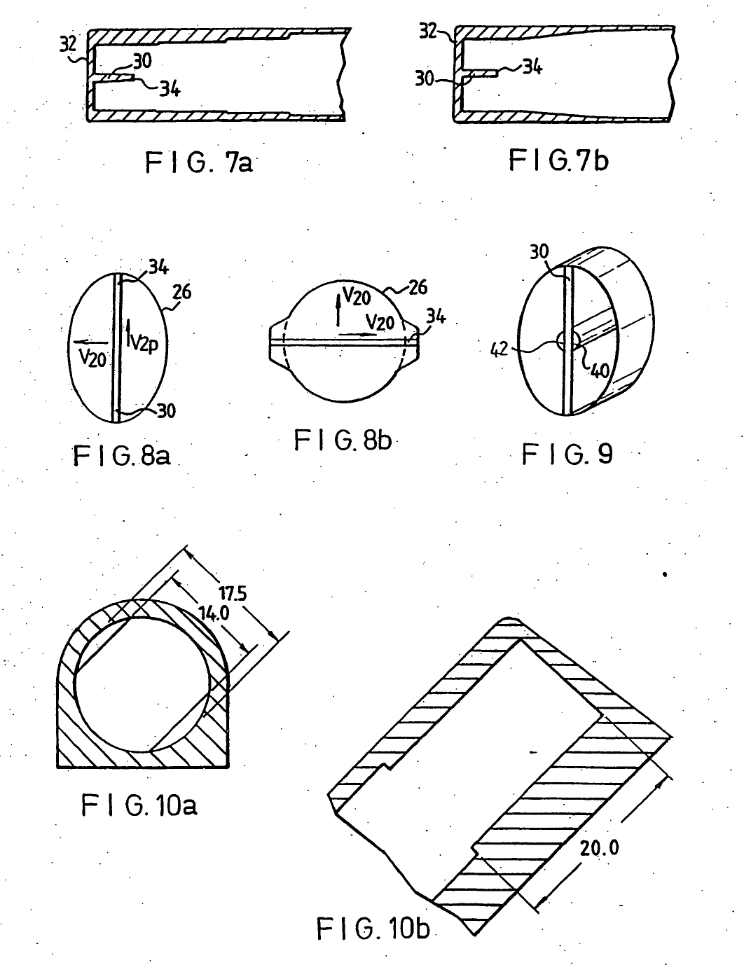

FIGS. 7a,b show rotators with alternative arrangements of flats in the waveguide wall.

FIGS. 8a,b show cross-sectional views through alternative slightly different differential phase shift portions of the waveguide.

FIG. 9 is a view similar to FIG. 8b but with the reflecting plate having protuberances for suppressing insertion loss ‘glitches’.

FIGS. 10a, 10b are side and longitudinal cross-sectional views through a waveguide with no reflecting or twist plate and a differential phase section of flats only;

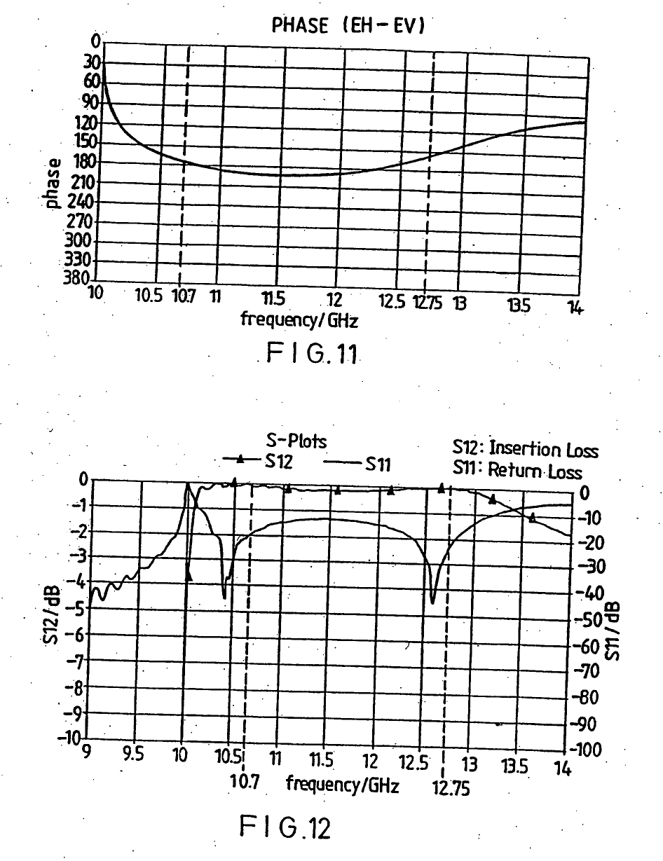

FIG. 11 is a graph of phase shift vs. frequency over the frequency range of interest for the waveguide shown in FIGS. 10a and 10b;

FIG. 12 is a graph of insertion loss and return loos over the frequency range of interest for the waveguide shown in FIGS. 10a, 10b;

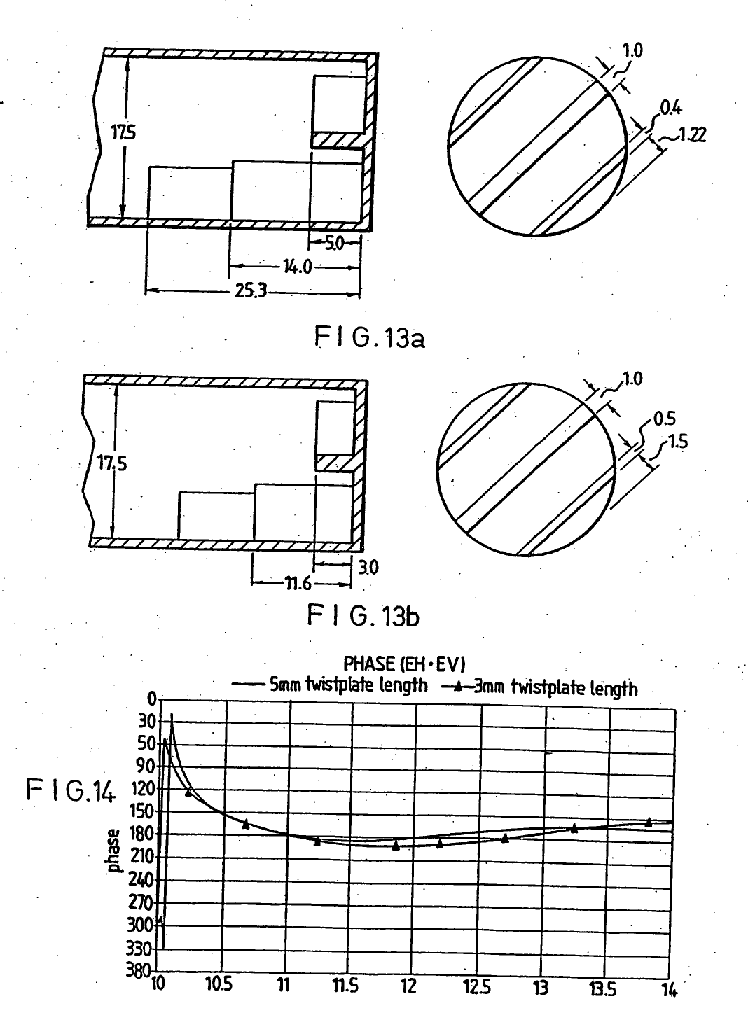

FIGS. 13a, 13b show longitudinal sections of waveguides, similar to FIG. 3, for a 5 mm reflecting plate and 3 mm reflecting plate respectively;

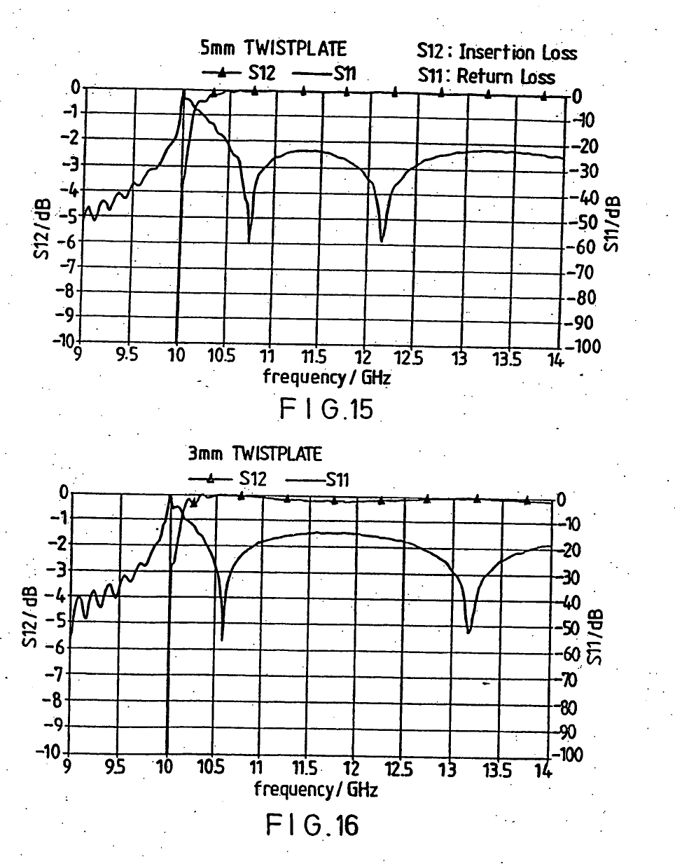

FIGS. 14, 15 and 16 are graphs of phase vs. frequency and insertion loss and return loss vs. frequency for the waveguides with 5 mm and 3 mm plates shown in FIG. 16.

Reference is first made to FIG. 1 of the drawings in which a low-noise block receiver, generally indicated by reference numeral 10, is adapted to be mounted to a satellite receiving dish in a way which is well known in the art. As is also known, the low-noise block receiver 10 is arranged to receive high frequency radiation signals from the satellite dish and to process these signals to provide an output which is fed to a cable 12 which is, in turn, connected to a satellite receiver decoder unit (not shown in the interests of clarity). The block receiver 10 includes a waveguide 14 which is shown partly broken away in the interests of clarity to depict the interior components. The waveguide is cylindrical and is metal. The waveguide has front aperture 16 for facing a satellite dish for receiving electromagnetic radiation from a feed horn 18, shown in broken outline, which is mounted on the front of the waveguide. The waveguide and feed horn 18 are substantially the same as that disclosed in applicant's co-pending International Application PCT/GB96/00332 and WO 92/22938. Accordingly, disposed in the waveguide in the same longitudinal plane is a first probe 20, a reflective post 22 and a second probe 24. In this embodiment, the reflective post 22 extends across the entire diameter of the interior of the waveguide. The outputs of the probes 20 and 24 pass through the waveguide wall 26 along the same longitudinal plane generally indicated by reference numeral 28. The distance between the probe 20 and reflective post 22, and between probe 24 and reflective post 22 is nominally λ/4 where λ is the wavelength of the signals in the waveguide. At the downstream end of the waveguide which furthest from the front aperture, there is disposed within the waveguide the reflecting plate 30. As best seen in FIG. 2, the reflecting plate is oriented at an angle of 45° to the probes 20,24 and reflecting-post 22. The furthest end of the plate terminates in a wall 32 which acts as a short circuit and which will be later described in detail.

It will be seen that the reflecting plate is thin and has a single leading edge 34 which is orthogonal to the waveguide axis. Edge 34 is a fixed distance from the short circuit 32. With this arrangement, it will be appreciated that there is a single reflecting edge at the leading end of the reflecting plate 30 spaced by a predetermined distance from wall 32.

Referring now to FIGS. 2 to 4, in the interior of the waveguide two sets of flats, 36,38, are cast in the side of the waveguide. In the embodiment shown, the two sets of flats 36,38, which are disposed parallel to the reflecting plate 30 as best seen in FIG. 2. Flats 36 are cast further into the waveguide wall than flats 38 so that the waveguide has a profile as best shown in FIG. 4 where the waveguide appears to converge towards the base of the reflecting plate 30. The flats create a waveguide of slightly asymmetrical cross-section providing the differential phase shift portion. The dimensions of flats (in millimetres) in relation to the size of the reflecting plate are shown in FIG. 3.

In operation, signals from a satellite dish enter the waveguide 14 via the horn 18 and aperture 16 and, in accordance with known principles, are transmitted along the waveguide 14. The signals which are broadcast by the satellite include two sets of signals which are orthogonally polarised in the same frequency band and these are represented by vectors V1 and V2 (FIG. 1) which are signals polarised in the vertical and horizontal planes respectively. The flats in the waveguide have the effect of modifying the cut-off wavelength of the waveguide for both orthogonal V_{2O} and V_{2P} components as indicated below. The change in cut-off wavelength leads to a change in the guide wavelength λ_{g} since the two are related to each other as indicated below.

$$\frac{1}{{λ}_{g}^{2}} = \frac{1}{{λ}_{o}^{2}} - \frac{1}{{λ}_{c}^{2}} \begin{matrix}λ o = Free space wavelength \\ λ g = Guide wavelength \\ λ c = Cut \text{-} off wavelength\end{matrix}$$

Since V_{2P} and V_{2O} have different guide wavelengths, there will be a resultant phase shift between them per unit length of waveguide. This phase shift is a function of frequency, more phase shift being obtained at lower frequency. This can be seen by the graph shown in FIG. 5. The difference in wavelength is greater at lower frequencies since λ_{g} tend to infinity as cut-off is approached and tends to λₒ at higher frequencies. This variation of phase shift with frequency is opposite to the variation from the reflecting plate. As the signals travel along the waveguide the vertically polarised signal V1 is received by the first probe 20 which, as it is spaced by λ/4 from the reflecting post 22, ensures the maximum field at the probe and hence optimum coupling to the probe. The probe 20 has no effect on the horizontally polarised signal V2 which continues to pass along the waveguide.

Because the reflecting post 22 is vertically oriented, the signal V2 is not reflected by the post and continues to pass along the waveguide and also passes the second probe 24 for the same reason. As the horizontally polarised signal V2 hits the front edge of the reflecting and rotating means (the start of the flats), the signal is split into V_{2P} and V_{2O}. The influence of the flats phase shifts V_{2P} with respect to V₂₀, when the signal encounter the plate, V_{2P} is reflected by edge 34. The combination of the phase shift introduced by the flats and the plate gives 180° signal shift between the reflected signals V_{2OR} and V_{2PR} at the start of the flats, which on recombination provides an output signal V_{2R}.

Reference is now made to FIGS. 6a, b, c and d of the drawings. Referring first to FIG. 6a, it will be seen that this is a graph of phase shift deviation from 180° from the rotator shown in FIGS. 1 to 4 with frequency over the Astra satellite range 10.7-12.75 GHz. It will be seen that the phase shift is substantially 180° across the entire frequency range for a reflected signal in orientation V_{2PR} with respect to signal V_{2OR}. This offers substantial improvement over the arrangement provided by the prior art twist plate arrangement as disclosed in applicant's co-pending Application No. PCT/GB96/00332. The prior art responses are shown in broken outline in FIGS. 6a,b,c and d. This effectively means that the recombination of the signal is much better and in the plane of the second probe providing a better frequency response and insertion loss.

In this regard, reference is made to FIG. 6b of the drawing which shows the insertion loss with the rotator of the embodiments shown in FIGS. 1 to 4 compared with the insertion loss of the stepped twist plate arrangement as disclosed in the aforementioned application. It will be seen that the insertion loss or transmission loss in decibels is much less than the prior art arrangement, especially at the upper and lower frequency limits of the band. This means that there is a much better frequency response and signal response in these frequency regions.

FIG. 6c is a graph of signal return loss (dB. V. frequency) which shows that there is less signal loss across the entire frequency range compared to the existing stepped twist plate and that there is a broader band of frequency for minimal return loss which shows a general improvement across the frequency band.

Referring to FIG. 6d, this shows an enlarged view of FIG. 5a where it will be seen that the phase shift characteristic is substantially flat around 180° and it will be seen that this offers a significant improvement over the prior art arrangement which is shown in broken outline.

In some cases, an insertion loss may occur over a relatively narrow bandwidth of a few MHz. This is believed to be due to manufacturing tolerances which result in a slight asymmetry of the twist plate/reflecting plate. One solution to this problem has been to place small semi-cylindrical protuberances 40, 42 on the twist plate 30 as shown in FIG. 9 which results in suppression of the insertion loss to an acceptable level. These protuberances 40, 42 are cast with the reflecting plate 30.

Reference is also made to FIGS. 10a, 10b and 11 and 12 of the drawings which shows a waveguide which does not have a twist or reflecting plate. In FIGS. 10a, 10b it will be seen that the waveguide has flats 46 only. Otherwise, it is the same as the waveguide shown in FIG. 1. For a waveguide with the dimensions shown, FIG. 11 shows the phase shift over the frequency range of interest (10.7 to 12.75 GHz.) and FIG. 12 shows a graph of insertion loss and return loss against frequency. From FIGS. 11 and 12 it will be seen that this waveguide performs quite well over the band of interest and as well as the stepped twist plate disclosed in applicant's co-pending Application PCT/GB96/00332.

For example, FIGS. 14, 15 and 16 show graphs comparing the preference of the same diameter waveguide (17.5 mm) with different lengths of reflecting plate (5 mm and 3 mm respectively) and different lengths of flats as shown in FIGS. 13a, 13b. The 5 mm version moves any small insertion loss ‘glitches’ outside the top of the frequency band with a small performance penalty.

Various modifications may be made to the rotator structure for use with the waveguide as hereinbefore described without departing from the scope of the invention. For example, a single parallel flat may also be used or two or more pairs of flats may be machined into the side of the waveguide as shown in FIG. 7a. In addition, flats need not be stepped but may be provided by a smooth transition curve as shown in FIG. 7b of the drawings. Also, the asymmetry of the waveguide cross-section can be provided by a number of different shapes, for example elliptical, as shown in FIG. 8a or with a wider cross-section as shown in FIG. 8b. It will be appreciated that the exact dimensions of the flats, or transition curve and cross-sections, and the size of the reflecting plate, may be varied in accordance with specific signal and frequency range requirements. It will also be understood that the protuberances may be of any suitable shape and can be single or double. They may be installed onto the reflecting plate after casting.

A ‘suitable shape’ is one which results in suppression of any insertion loss over the narrow bandwidth due to plate asymmetry. However, it will be understood that the basic invention is a combination of reflecting plate and the differential phase shift section in the sides of the waveguide, in which a differential phase shift portion is provided by a cross-section of slight asymmetry so that reflected orthogonal components of the second orthogonally polarised signals have different wavelength cut-offs which when recombined create a recombined reflected signal which has a substantially 180° phase shift across the desired frequency range.

It will be appreciated that the principal advantage of the present invention is that the reflecting and rotating arrangement allows the LNB to be used across the existing satellite bandwidth but which provides a much better frequency characteristic at the upper and lower frequency limits. This allows an increased number of channels to be used across the entire frequency band with substantially the same performance, that is providing minimal degradation at the edges of the frequency band. A further advantage of this arrangement is that it can be used with existing manufacturing techniques and does not require any special fabrication. It will also be understood that this particular apparatus and methodology may be applied to providing bandwidth improvements at frequency ranges outside the aforementioned Astra frequency range.

1. A waveguide for use with a dual polarisation waveguide probe system for receiving at least two signals which are orthogonally polarised, said waveguide comprising a waveguide tube into which at least two orthogonally polarised signals are received for transmission therealong, said waveguide having;
a first probe extending from a wall of the waveguide into the interior of the waveguide, said first probe being adapted to receive said orthogonal signal travelling in the same longitudinal plane thereof,
reflector means extending from the wall of the waveguide, through reflector means located downstream of the first probe lying in the longitudinal plane for reflecting signals in said first orthogonal plane back to said first probe means and allowing said signal in said second orthogonal plane to pass along the waveguide, second probe means located downstream of said first reflector means and-extending from wall of said waveguide into the interior of the waveguide and lying in said longitudinal plane, signal reflecting and rotating means, including a short circuit at the end of the waveguide, located downstream of said second probe means for receiving, rotating and reflecting said second orthogonally polarised signal back along said waveguide such that the rotated and reflected signal is received by said second probe means, said signal reflecting and rotating means comprising a first reflecting and rotating means in the form of a plate with a leading edge thereon to provide at least one reflecting edge portion for reflecting a first component of said second orthogonally polarised signal, the reflecting edge portion being spaced at a desired distance from the short circuit at the end of the waveguide, a differential phase shift means disposed in proximity to the rotating. plate, said differential phase shift means having a slightly asymmetrical cross-section, whereby said first and second components of said second orthogonally polarised signal are phase shifted with respect to each other in the differential phase shift portion, then reflected respectively from said reflecting edge portion and from said short circuit before being further phase shifted when travelling back through the differential phase shift portion for recombination, said first and second components having different cut-off wavelengths, to-provide a recombined signal for detection by said second probe means.

2. A waveguide as claimed in claim 1 wherein said reflecting and rotating means. has a single: reflecting edge portion across the width of the waveguide.

3. A waveguide as claimed in claim 1 wherein the differential phase shift means is provided by an asymmetric structure in the form of flats cast into the interior of the waveguide structure.

4. A waveguide as claimed in claim 3 wherein two flats are provided on each side, the flats being parallel with and extending along the waveguide from the reflector plate.

5. A waveguide as claimed in claim 1 wherein the slightly asymmetric portion is provided by an elliptical waveguide.

6. A waveguide as claimed in claim 4 wherein the upstream flats are machined a greater distance into the waveguide surface than the downstream flats with the first (downstream) flats forming an impedance matching structure.

7. A waveguide as claimed in claim 3 wherein the waveguide differential phase shift means is provided by at least two pairs of stepped flats.

8. A waveguide as claimed in claim 1 wherein the asymmetric portion is provided by a smooth transition along the waveguide.

9. A waveguide as claimed in claim 8 wherein the smooth transition is cast into the side of the waveguide parallel to the reflecting edge portion

10. A waveguide as claimed in claim 1 wherein at least one proturbence is provided on the reflector plate for suppressing any insertion loss glitches which occur within the desired frequency band.

11. A method of receiving at least first and second orthogonally polarised signals in a frequency range in a single waveguide and providing at least two outputs in a common longitudinal plane for providing a flatter characteristic across the frequency range, said method comprising the steps of,
providing a first probe in said waveguide to receive a first orthogonally polarised signal,
providing a reflecting means in said waveguide parallel to and downstream from said first probe for reflecting said first orthogonally polarised signal and for allowing passage of said second orthogonally polarised signal,
providing a second probe in said waveguide parallel to and downstream of said reflector means, said second probe being substantially orthogonal to said second orthogonally polarised signal which passes the second probe without being received by the second probe,
providing a signal reflecting and rotating means at the end of the waveguide for reflecting a first component of said second orthogonal signal back towards said second probe,
allowing a second component of said second orthogonal signal to travel towards said waveguide short circuit, modifying the length of said second component such that it has a different cut-off wavelength from said first component,
reflecting said second component from said waveguide short circuit,
recombining said first and second reflected components of said second orthogonal signal to create a recombined reflected signal, said recombined reflected signal being in the same plane as said second probe for detection thereby, said first and second reflected components having inverse frequency characteristics which combine to create a flatter frequency response across said frequency range.

12. A method as claimed in claim 11 including the step of forming the reflecting and rotating means by combining a differential phase shift section and a reflecting plate

13. A method as claimed in claim 11 wherein a phase shift between the first and second portions of the orthogonal signal is introduced by orienting the differential phase shift section at 45° to the incident signal.

14. A method as claimed in claim 11 including the step of providing proturbences, on the twist plate to minimise insertion loss glitches within the frequency band of interest.

15. A dual polarisation waveguide probe structure, said structure having a waveguide, first and second probes disposed in the waveguide separated by a first reflector, said first and second probes and said ref lector being disposed in the same plane, second probe signal providing means for providing a polarised component to said second probe, said second probe providing means comprising a signal reflecting and rotating means for reflecting and rotating a polarised component for reception by said second probe, said reflecting and rotating means comprising a reflected edge portion for reflecting a first component of said polarised signal, and a differential-phase portion provided by a slightly asymmetrical waveguide portion and a waveguide short circuit for providing a reflected second component with a different cut-off wavelength from said first component, the first and second components having inverse frequency characteristics which when recombined provide a flatter frequency characteristic across the frequency range.

16. A waveguide for use with a dual polarisation waveguide system for receiving at least two signal which are orthogonally polarised, said waveguide comprising a waveguide tube into which at least two orthogonally polarised signals are received for transmission therealong, said waveguide having;
a first probe extending from a wall of the waveguide into the interior of the waveguide, said first probe being adapted to receive said orthogonal signal travelling in the same longitudinal plane thereof,
reflector means extending from the wall of the waveguide, through reflector means located downstream of the first probe lying in the longitudinal plane for reflecting signals in said first orthogonal plane back to said first probe means and allowing said signal in said second orthogonal plane to pass along the waveguide, second probe means located downstream of said first reflector means and extending from wall of said waveguide into the interior of the waveguide and lying in said longitudinal plane, signal reflecting and rotating means, including a short circuit at the end of the waveguide, located downstream of said second probe means for receiving; rotating and reflecting said second orthogonally polarised signal back along said waveguide such that the rotated and reflected signal is received by said second probe means, said signal reflecting and rotating means also including, a differential phase shift means disposed between the second probe and the short circuit, said differential phase shift means-having a slightly asymmetrical cross-section, whereby said first and second components of said second orthogonally polarised signal are phase shifted with respect to each other in the differential phase shift portion, then reflected respectively from said short circuit before being further phase shifted when travelling back through the differential phase shift portion for recombination,’ said first and second components having different cut-off wavelengths, to provide a recombined signal for detection by said probe means.

17. A waveguide as claimed in claim 16 wherein the differential phase shift means is provided by an asymmetric structure in the form of flats cast into the interior of the waveguide structure.

18. A waveguide as claimed in claim 17 wherein two flats are provided on each side, the flats being parallel with and extending along the waveguide from the reflector plate.

19. A waveguide as claimed in claim 16 wherein the slightly asymmetric portion is provided by an elliptical waveguide.

20. A waveguide as claimed in claim 18 wherein the upstream flats are machined a greater distance into the waveguide surface than the downstream flats with the first (downstream) flats forming an impedance matching structure.

21. A waveguide as claimed in claim 17 wherein the waveguide differential phase shift. means is provided by at least two pairs of stepped flats.

22. A waveguide as claimed in claim 16 wherein the asymmetric portion is provided by a smooth transition along the waveguide.

23. A waveguide as claimed in claim 22 wherein the smooth transition is cast into the side of the waveguide parallel to the reflecting edge portion.
